(19) United States
(12) Patent Application Publication
(10) Pub. No.: US 2024/0338634 A1
(43) Pub. Date: Oct. 10, 2024

(54) Dynamic Control of Multi-Nested OKR Alignment

(71) Applicant: Microsoft Technology Licensing, LLC, Redmond, WA (US)

(72) Inventors: Kavish DWIVEDI, Bengaluru (IN); Nipun RAWAT, Delhi (IN); Thiruvenkadam RAJASEKARAN, Trichy (IN); Sampat CHOUDHARY, Jodhpur (IN); Tushar SINGHAL, Meerut (IN); Santhoshkumar SELLADURAI, Chennai (IN); Manoj CG, Chennai (IN); Shubhanjali AWASTHI, Patna (IN); Vishnu Prasath SRINIVASAN, Chennai (IN); Balaji BALASUBRAMANYAN, Redmond, WA (US); Murugesh SESHADRI, Chennai (IN); Elizabeth Anne PIERCE, Seattle, WA (US); Aniket DWIVEDI, Bengaluru (IN)

(73) Assignee: Microsoft Technology Licensing, LLC, Redmond, WA (US)

(21) Appl. No.: 18/297,760

(22) Filed: Apr. 10, 2023

(51) Int. Cl. G06Q 10/0639; G06Q 10/0637

(52) U.S. Cl. CPC G06Q 10/06393; G06Q 10/0637

(57) ABSTRACT

A method for dynamically controlling the alignment of multi-nested Objectives and Key Results (OKRs) is implemented via an application service provider server including a processor. The method includes executing, via a network, an enterprise application on a remote computing system and causing surfacing of a user interface on the display of the remote computing system during the execution of the enterprise application, where the user interface corresponds to a goal-setting feature of the enterprise application. The method also includes receiving, via the surfaced user interface, user input including an alignment permission policy for a multi-nested OKR of an enterprise, where the alignment permission policy defines a list of enterprise users who are allowed to align child OKR objects to a parent objective of the multi-nested OKR. The method further includes applying the alignment permission policy to the multi-nested OKR.

### BACKGROUND

The present disclosure generally relates to Objectives and Key Results (OKR) features provided by enterprise applications. More specifically, the present disclosure relates to the dynamic control of multi-nested OKR alignment.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a method for dynamically controlling multi-nested OKR alignment is described. The method is implemented via an application service provider server including a processor. The method includes executing, via a network, an enterprise application on a remote computing system and causing the surfacing of a user interface on the display of the remote computing system during the execution of the enterprise application, where the user interface corresponds to a goal-setting feature of the enterprise application. The method also includes receiving, via the surfaced user interface, user input including an alignment permission policy for a multi-nested OKR of a corresponding enterprise, where the alignment permission policy defines a list of enterprise users who are allowed to align child OKR objects to the parent objective of the multi-nested OKR. The method further includes applying the alignment permission policy to the multi-nested OKR.

In another embodiment, an application service provider server is described. The application service provider server includes a processor, an enterprise application that is utilized by an enterprise, and a communication connection for connecting a remote computing system to the application service provider server via a network. The application service provider server also includes a computer-readable storage medium operatively coupled to the processor. The computer-readable storage medium includes computer-executable instructions that, when executed by the processor, cause the processor to cause the execution of the enterprise application on the remote computing system and to cause the surfacing of a user interface on the display of the remote computing system during the execution of the enterprise application, where the user interface corresponds to a goal-setting feature of the enterprise application. The computer-readable storage medium also includes computer-executable instructions that, when executed by the processor, cause the processor to receive, via the surfaced user interface, user input including an alignment permission policy for a multi-nested OKR of an enterprise, where the alignment permission policy defines a list of enterprise users who are allowed to align child OKR objects to the parent objective of the multi-nested OKR. The computer-readable storage medium further includes computer-executable instructions that, when executed by the processor, cause the processor to apply the alignment permission policy to the multi-nested OKR.

In another embodiment, a computer-readable storage medium is described. The computer-readable storage medium includes computer-executable instructions that, when executed by a processor, cause the processor to cause execution of an enterprise application and to cause the surfacing of a user interface on a display during the execution of the enterprise application, where the user interface corresponds to a goal-setting feature of the enterprise application. The computer-readable storage medium also includes computer-executable instructions that, when executed by the processor, cause the processor to, responsive to a first user input including a specification of an alignment permission policy for a multi-nested OKR of an enterprise, apply the alignment permission policy to the multi-nested OKR, where the alignment permission policy defines a list of enterprise users who are allowed to align child OKR objects to a parent objective of the multi-nested OKR. The computer-readable storage medium further includes computer-executable instructions that, when executed by the processor, cause the processor to, responsive to a second user input including an attempt to align to the parent objective, determine whether an enterprise user providing the second user input is on the list of enterprise users who are allowed to align child OKR objects to the parent objective, as well as update the OKR to provide the alignment only if the enterprise user is on the list.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a process flow diagram of an exemplary method for dynamically controlling multi-nested OKR alignment according to embodiments described herein;

FIG. 2 is a process flow diagram of another exemplary method for dynamically controlling multi-nested OKR alignment according to embodiments described herein;

FIG. 3A is a schematic view of a user interface that is provided as part of a goal-setting feature of an enterprise application;

FIG. 3B is a schematic view of the user interface subsequent to the enterprise user providing input consisting of a selection of the first OKR user interface element;

FIG. 3C is a schematic view of the user interface subsequent to the enterprise user providing input consisting of a selection of the third OKR user interface element;

FIG. 3D is a schematic view of the user interface subsequent to the enterprise user providing input consisting of a selection of the permissions user interface element;

FIG. 3E is a schematic view of the user interface subsequent to the enterprise user providing input consisting of a selection of the unlimited viewing and limited alignment option via the alignment permission settings user interface element;

FIG. 4A is a schematic view of the user interface of FIG. 3 subsequent to the enterprise user providing input consisting of a selection of an objective alignment user interface element;

FIG. 4B is a schematic view of the user interface subsequent to the enterprise user providing input consisting of a selection of a particular objective to which the enterprise user desires to align;

FIG. 5 is a block diagram of an exemplary computing system for implementing the techniques described herein;

FIG. 6 is a block diagram of an exemplary network environment for implementing the techniques described herein; and

FIG. 7 is a block diagram of an exemplary computer-readable storage medium for implementing the techniques described herein.

### DETAILED DESCRIPTION

Objectives and Key Results (OKRs) are utilized as part of a goal-setting framework to enable enterprises to achieve desired outcomes. In particular, objectives are overarching goals that the enterprise (or some team within the enterprise) desires to accomplish, while key results define the metrics for determining when the corresponding objective has been met. Therefore, while objectives are qualitative, key results are quantitative. In addition, while objectives are often created at the enterprise or organizational level, the corresponding key results may be broken down at the team level or even at the individual user level. Furthermore, in some cases, the metrics represented by the key results may be further broken down into projects, where each project is aimed at fulfilling one or more key results.

Some modern enterprise applications (such as, in particular, Microsoft® Viva® provided by Microsoft Corporation) include goal-setting features (such as, in particular, Microsoft® Viva® Goals) that enable enterprise users (e.g., owners, administrators, team managers, and/or employees) to create and track the enterprise's OKRs. The integration of such goal-setting features directly into enterprise applications is designed to enable enterprise users to unite around the enterprise's strategic priorities, mission, and purpose, thus fostering a highly-productive and engaged work culture that drives successful business outcomes.

Such goal-setting features may enable various OKR-related tasks, including the creation and tracking of multi-nested OKRs. As used herein, the term “multi-nested OKR” refers to an OKR structure in which multiple objectives, key results, and/or projects are defined in a hierarchical configuration. As an example, a single parent objective may include multiple key results (e.g., typically three to five key results) nested underneath it. Each key result may, in turn, include one or more projects nested underneath it. Moreover, in some cases, secondary objectives and/or secondary key results can be nested underneath one or more key results. In this manner, each multi-nested OKR is defined as a tree structure, in which progress is rolled up to the parent OKR. In particular, each key result contributes to the parent objective according to a predetermined percentage. When progress is made on a particular key result (or the key result is completed), the completion percentage of the parent objective is automatically updated to reflect the current status of the key results. In this manner, enterprises are provided with a data-driven, quantitative approach for meeting qualitative goals.

However, inefficiencies are still present in multi-nested OKR solutions. In particular, the OKR alignment is not always optimized, where the term “alignment” refers broadly to the OKR structure or, more specifically, to the configuration of objectives and key results (and, optionally, projects) that are connected to each other. (More specifically, when a particular key result is “aligned” to a particular objective, the key result contributes to the objective's progress). Moreover, such alignment issues arise when a particular enterprise user (or team) chooses to align a particular key result to a specific objective even though the key result does not fit that objective. In this case, the completion of the key result may inaccurately appear to partially fulfill the objective.

Such misalignment of OKRs causes significant issues with respect to multi-nested OKRs since misalignment to the tree will result in incorrect progress rollups to the parent objective, thus hindering the overall performance of the parent objective. Therefore, the present techniques address these issues by providing for the dynamic control of multi-nested OKR alignment. Specifically, the present techniques provide for the dynamic control of alignment permissions for OKRs via a user interface provided within the context of a goal-setting feature of an enterprise application. In an exemplary embodiment, the user interface is provided by Microsoft® Viva® Goals during the execution of Microsoft® Viva®, and the alignment permissions are defined in response to input from the corresponding OKR owner. In this manner, OKR progress rollups are controlled, thus preventing such progress rollups from being negatively impacted by misalignment issues.

As used herein, the term “enterprise application” may refer to any suitable types of web-based applications, mobile applications, and/or other applications/services that are provided by an application service provider. Moreover, the term “enterprise application” is used herein with reference to an application that forms part of a suite or package of products/services (or some subset of such suite/package) that is provided by the application service provider to enable users who are associated with an enterprise to interact with their corresponding computing systems to perform tasks relating to the enterprise, including OKR-related tasks. As a non-limiting example, if the application service provider is Microsoft Corporation, the enterprise applications described herein may include (but are not limited to) Microsoft® Viva®, Microsoft® Teams®, Microsoft® Outlook®, and/or Microsoft® Yammer® (among others). More generalized examples of suitable enterprise applications include (but are not limited to) email/communication applications, social networking applications, employee experience applications, and the like. In other words, the techniques described herein may be implemented within the context of a broad range of web-based applications, mobile applications, and/or additional applications/services that are utilized for enterprise-related tasks, including OKR-related tasks. More broadly speaking, the term “enterprise application” may refer to any type of application or service that supports the OKR features described herein.

Furthermore, the term “goal-setting feature” is used herein to refer to a tool or feature of an enterprise application that enables the OKR-related tasks described herein. Thus, while Microsoft® Viva® Goals is provided as an exemplary embodiment of such a goal-setting feature, those skilled in the art will appreciate that any other suitable type of tool or feature could be utilized as long as it supports the OKR-related tasks described herein.

As used herein, the term “parent objective” refers to the highest-level objective considered in a particular case (even if some higher-level objective(s) and/or other OKR object(s) exist within the hierarchical OKR structure), and the term “child OKR object” refers to any and all key results, projects, and/or secondary objectives that are nested underneath the particular parent objective.

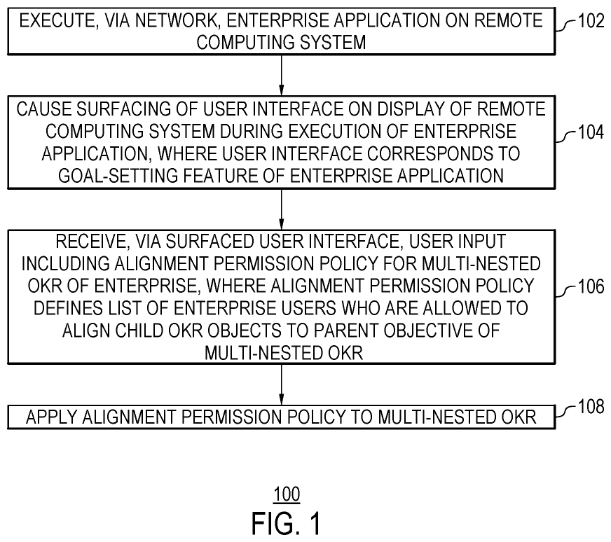

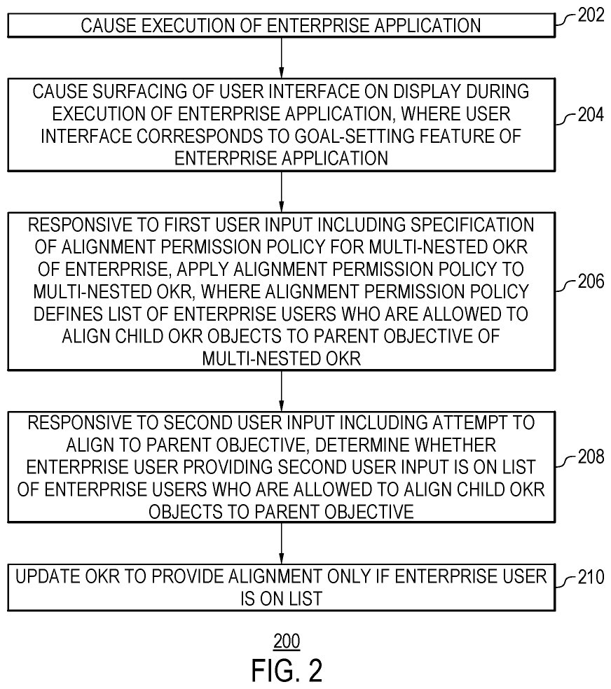

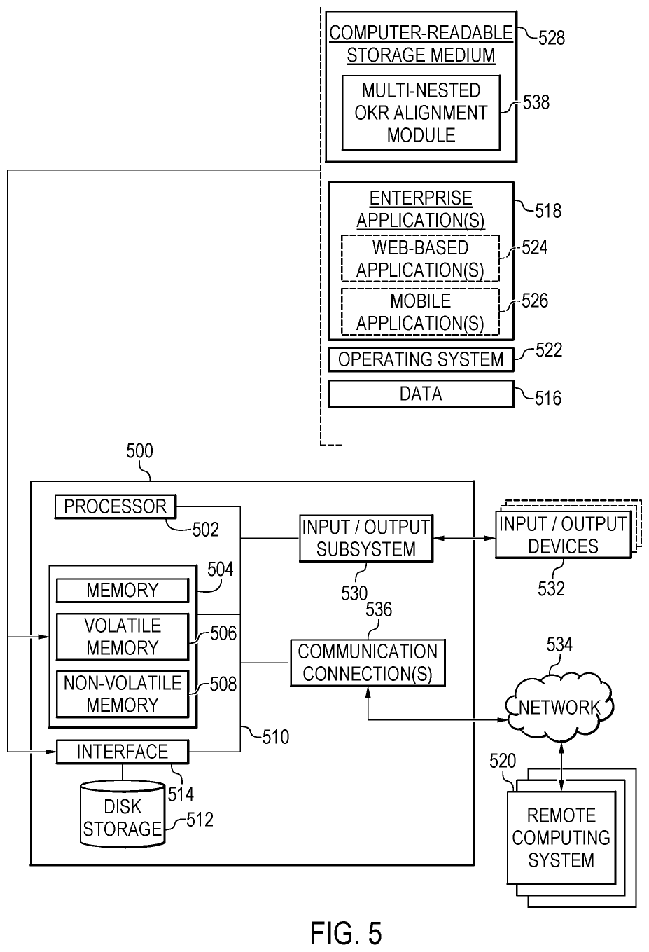

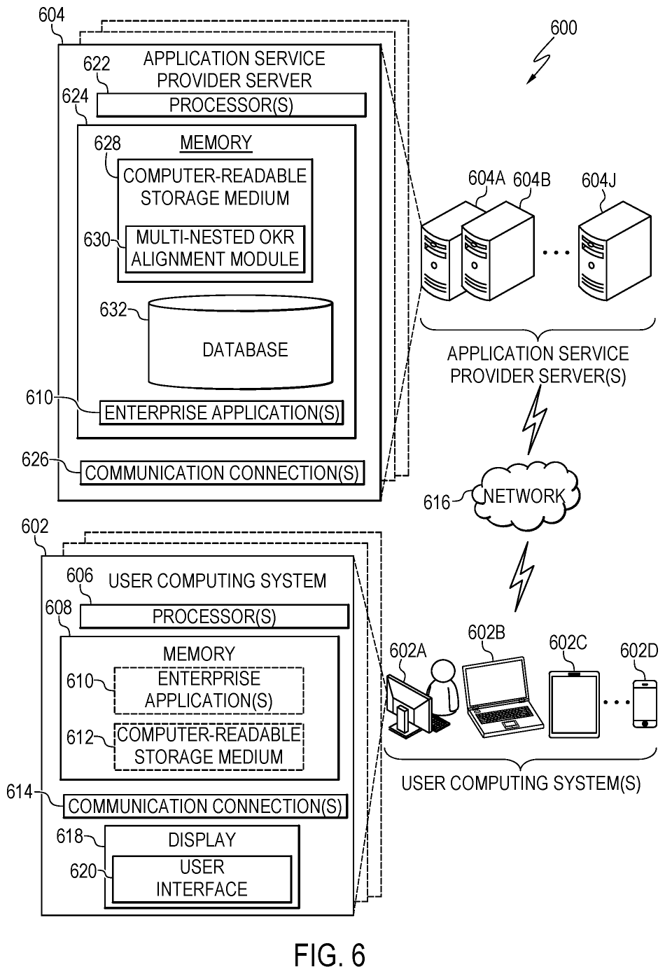

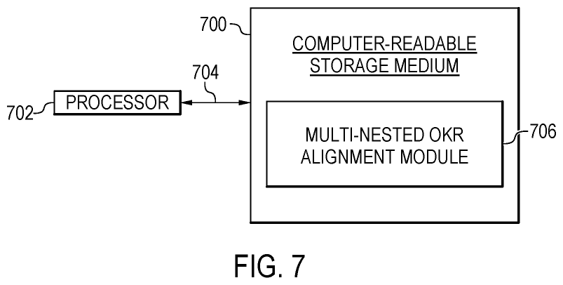

Turning now to a detailed description of the drawings, FIGS. 1 and 2 are process flow diagrams of exemplary methods 100 and 200, respectively, for dynamically controlling multi-nested OKR alignment according to embodiments described herein. Each method 100 and 200 is executed via one or more computing systems, such as the exemplary computing system described with respect to FIG. 5. In particular, in various embodiments, the computing system(s) implementing the method 100 and/or 200 includes computing system(s) or server(s) that are run by an application service provider that provides for the execution of one or more enterprise applications on remote computing systems. The computing system(s) include one or more processors and one or more computer-readable storage media including computer-executable instructions that, when executed by the processor(s), cause the processor(s) to perform the blocks of the method 100 and/or 200. An exemplary embodiment of such computer-readable storage media is described with respect to FIG. 7. Moreover, in various embodiments, the method 100 and/or 200 is executed within the context of a network environment including one or more application service provider computing system(s)/server(s), as described further with respect to the exemplary network environment of FIG. 6.

Turning first to FIG. 1, the method 100 begins block 102, at which an enterprise application is executed on a remote computing system via a network. At block 104, a user interface is surfaced (or caused to be surfaced) on the display of the remote computing system during the execution of the enterprise application, where the user interface corresponds to a goal-setting feature of the enterprise application, as described herein.

At block 106, user input including an alignment permission policy for a multi-nested OKR of an enterprise is received via the surfaced user interface, where the alignment permission policy defines a list of enterprise users who are allowed to align child OKR objects to the parent objective of the multi-nested OKR. In various embodiments, the child OKR objects include one or more key results, one or more projects, and/or one or more secondary objectives that are nested underneath the parent objective in the OKR tree structure. Moreover, in various embodiments, the list of enterprise users includes one or more individual enterprise users and/or one or more teams of enterprise users who are allowed to align (or contribute) to the multi-nested OKR per the defined alignment permission policy (and corresponding alignment permission properties of the multi-nested OKR).

At block 108, the alignment permission policy is applied to the multi-nested OKR via the goal-setting feature of the enterprise application. In various embodiments, the method 100 further includes applying the alignment permission policy to any secondary objectives that are nested underneath the parent objective. Moreover, in various embodiments, the method 100 also includes performing automatic progress rollups in accordance with the alignment permission policy by only enabling child OKR objects defined by enterprise users who are on the list to roll up to the parent objective.

In some embodiments, the method 100 also includes executing, via the network, the enterprise application on a second remote computing system, as well as causing the surfacing of the user interface on the display of the second remote computing system during the execution of the enterprise application. In such embodiments, the method 100 also includes receiving, via the surfaced user interface, second user input including an attempt to align to the parent objective, determining whether the enterprise user providing the second user input is on the list of enterprise users who are allowed to align child OKR objects to the parent objective, and updating the OKR to provide the alignment only if the enterprise user is on the list. Furthermore, in some such embodiments, the method 100 includes determining whether the enterprise user providing the second user input is on the list of enterprise users who are allowed to align child OKR objects to the parent objective by: (a) calling an application programming interface (API) in the background when the enterprise user provides the second user input; (b) loading the alignment permission policy in near real-time via the API; and (c) analyzing the alignment permission policy in near real-time to determine whether the enterprise user is on the list.

Turning now to FIG. 2, the method 200 begins block 202, at which an enterprise application is caused to be executed. At block 204, a user interface is caused to be surfaced on a display during the execution of the enterprise application, where the user interface corresponds to a goal-setting feature of the enterprise application. At block 206, responsive to first user input including the specification of an alignment permission policy for a multi-nested OKR of an enterprise, the alignment permission policy is applied to the multi-nested OKR, where the alignment permission policy defines a list of enterprise users who are allowed to align child OKR objects to a parent objective of the multi-nested OKR. At block 208, responsive to second user input including an attempt to align to the parent objective, a determination is made about whether the enterprise user providing the second user input is on the list of enterprise users who are allowed to align child OKR objects to the parent objective. In various embodiments, this is accomplished by calling an API in the background when the enterprise user provides the second user input, loading the alignment permission policy in near real-time via the API, and analyzing the alignment permission policy in near real-time to determine whether the enterprise user is on the list. Furthermore, at block 210, the OKR is updated to provide the alignment only if the enterprise user is on the list.

The block diagram of FIGS. 1 and 2 are not intended to indicate that the blocks of the method 100 and/or 200 are to be executed in any particular order, or that all of the blocks of the method 100 and/or 200 are to be included in every case. Moreover, any number of additional blocks may be included within the method 100 and/or 200, depending on the details of the specific implementation.

The present techniques provide various advantages over conventional OKR solutions. As an example, the present techniques provide for the dynamic control of OKR alignment to prevent inaccurate progress rollups from affecting the enterprise's objectives. As another example, the present techniques involve optimistically loading the alignment permission properties for an objective when the user clicks on the objective by calling application programming interfaces (APIs) in the background. As a result, the alignment permission policy details are immediately available for viewing, without any extra load time. As another example, the present techniques treat progress rollups as a dynamically-calculated property in the sense that the progress rollups adhere to the defined alignment permission policies, even when such alignment permission policies are updated in near real-time. This is significantly more efficient than running a background job that computes the progress rollups every few hours. As another example, the OKR creation and alignment details are generally defined at the entity level (e.g., teams and/or organizations), which is in agreement with the nested architectural structure of a typical enterprise. (For example, if node B is nested under node A in a tree, node B can borrow node A's alignment permission policies if required, which reduces misalignment-related errors. Notably, however, only nodes that are included within the subtree of another node can borrow the parent node's properties.) As yet another example, the present techniques enable OKR alignment to be directly controlled or restricted, which provides multiple advantages. Such advantages include, but are not limited to, preventing internal information from being exposed to an unnecessarily large group of people, ensuring that progress rollups are correctly calculated and cannot be tampered with, and preventing misalignment and unintended changes to progress calculations, especially during critical events such as townhalls, board meetings, and reviews when the live state of the OKR is presented directly from the tool.

The following is a description of two exemplary implementations of the techniques described herein for particular use-case scenarios. Those skilled in the art will appreciate that such exemplary implementations are for illustrative purposes only. In practice, the techniques described herein may be implemented in any other suitable manner to achieve any other suitable results, depending on the details of the particular implementation.

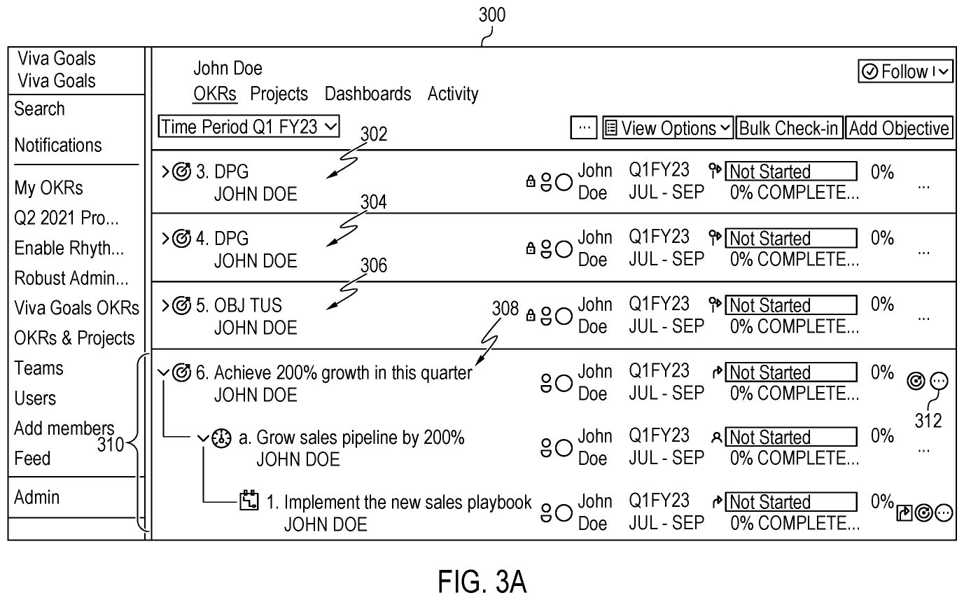

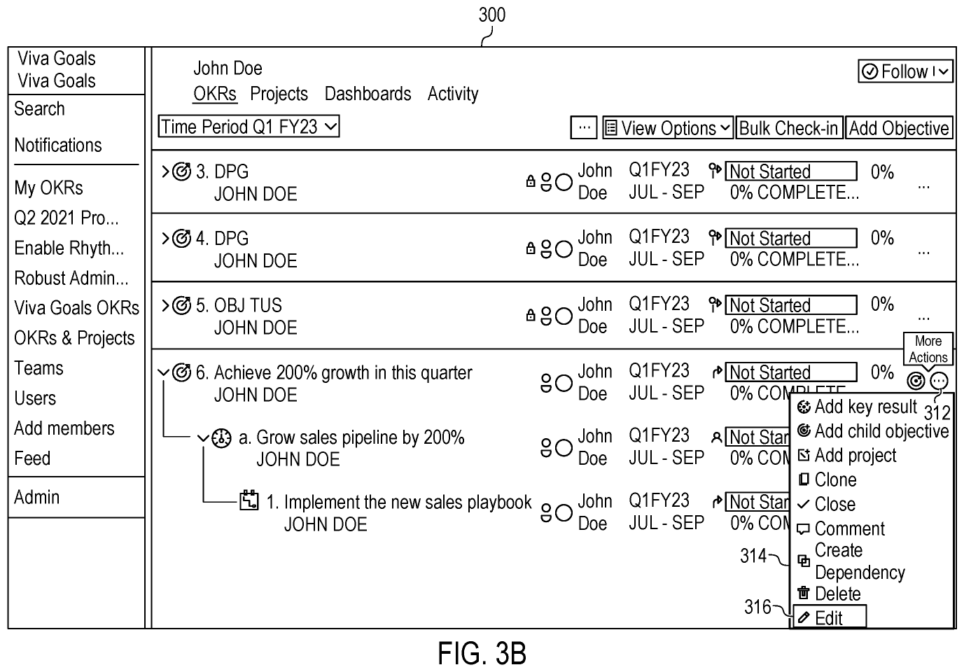

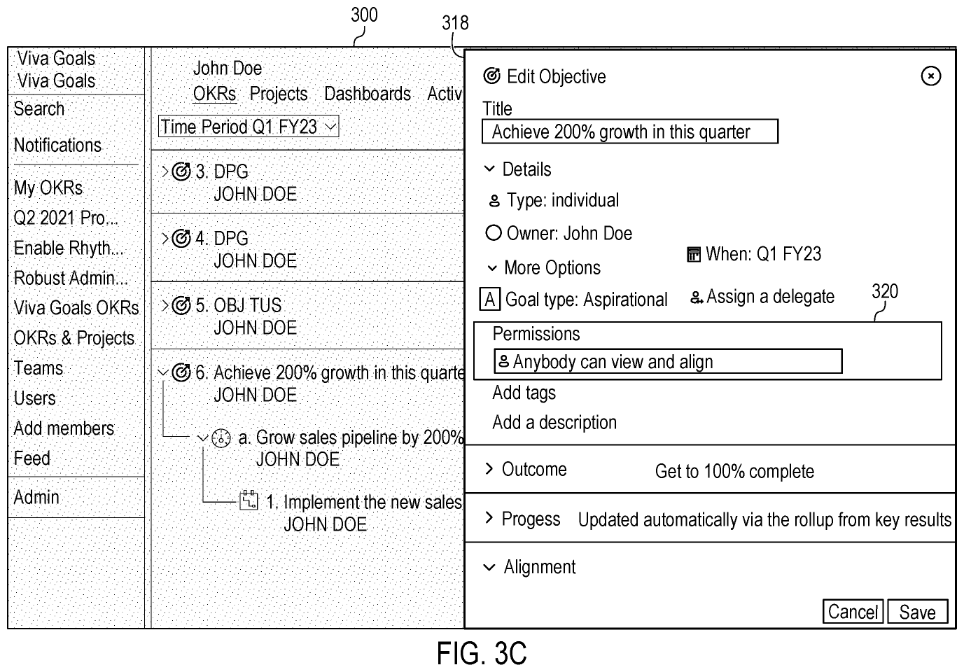

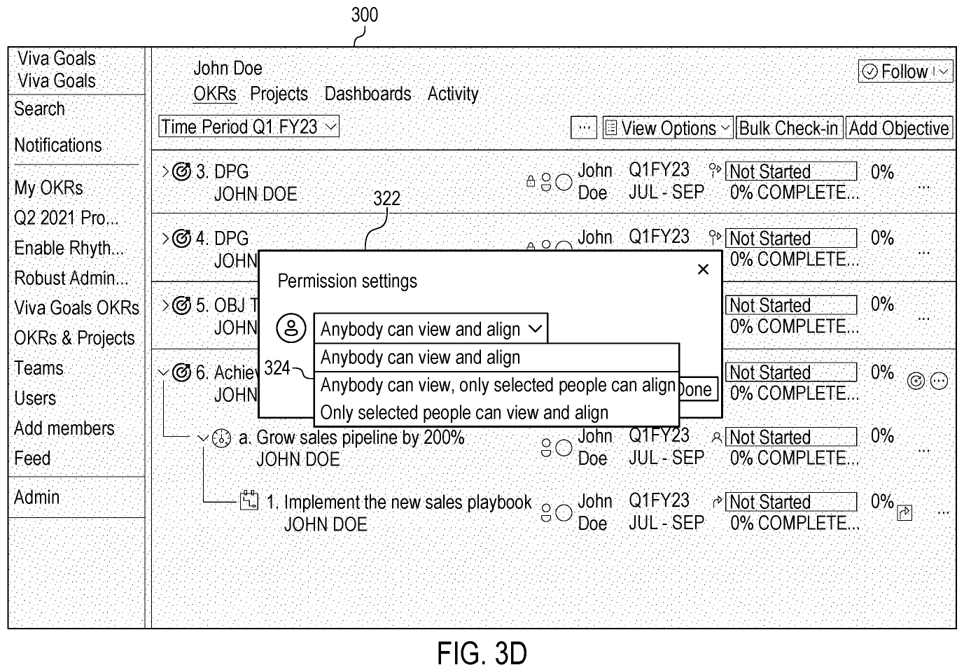

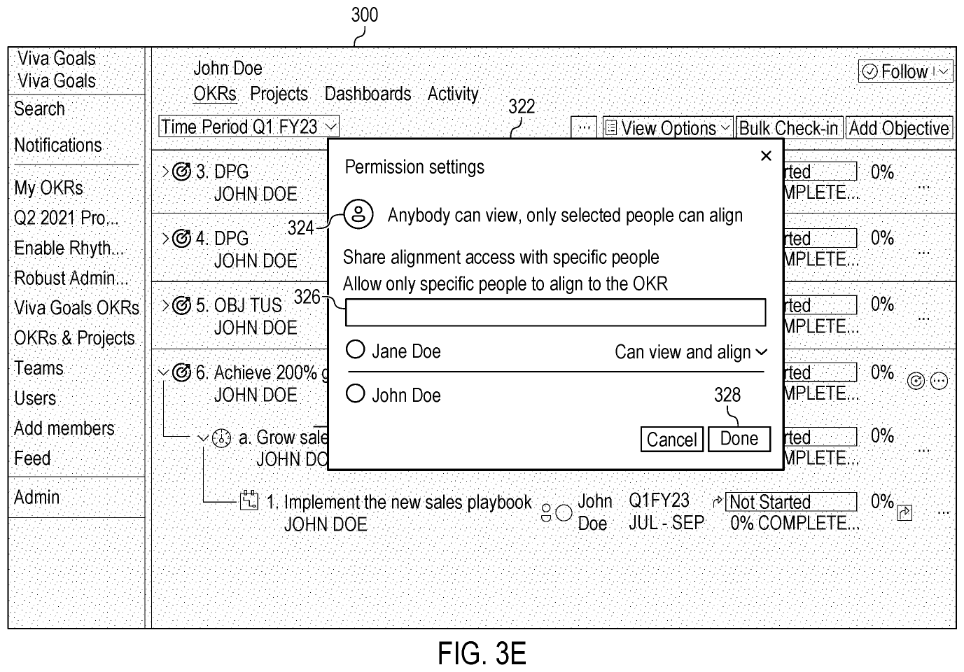

Turning now to the details of the first exemplary implementation, FIGS. 3A, 3B, 3C, 3D, and 3E depict the manner in which the techniques described herein can be used to dynamically control the alignment of multi-nested OKRs within the context of a goal-setting feature of an enterprise application, e.g., in this exemplary case, Microsoft® Viva® Goals provided by Microsoft® Viva®. Specifically, FIG. 3A is a schematic view of a user interface 300 that is provided as part of the goal-setting feature of the enterprise application. According to the embodiment shown in FIG. 3A, the user interface 300 is displaying a “My OKRs” view in which multiple OKRs 302, 304, 306, and 308 are listed, with the fourth OKR 308 being expanded to show at least a portion of the underlying tree structure 310. Specifically, the fourth OKR 308 includes a parent objective titled “Achieve 200% growth in this quarter,” along with a number of child OKR objects (including a key result titled “Grow sales pipeline by 200%” and a project titled “Implement the new sales playbook”). The child OKR objects are contributing children who are aligned to the parent objective in the sense that the progress of each child OKR object automatically rolls up to the parent objective, thus impacting the completion percentage of the parent objective.

As shown in FIG. 3A, the user interface 300 includes a number of user interface elements that enable the enterprise user (e.g., the OKR owner) to create and control OKRs. Notably, such user interface elements may be provided in any suitable form, including as buttons, toggles, dropdown menus, search boxes, and the like, and are therefore not limited to the specific embodiment shown in the figures. Moreover, in various embodiments, such user interface elements include a first OKR user interface element 312, which is depicted as a “More Actions” button according to the embodiment shown in FIG. 3A.

FIG. 3B is a schematic view of the user interface 300 subsequent to the enterprise user providing input consisting of a selection of the first OKR user interface element 312 (e.g., by clicking on the “More Actions” button). As shown in FIG. 3B, in various embodiments, a second OKR user interface element 314 (e.g., a “More Actions” dropdown menu) is displayed, and the enterprise user may then select from multiple additional OKR user interface elements. In various embodiments, the enterprise user responds by selecting a third OKR user interface element 316, which is depicted as an “Edit” button according to the embodiment shown in FIG. 3B.

FIG. 3C is a schematic view of the user interface 300 subsequent to the enterprise user providing input consisting of a selection of the third OKR user interface element 316 (e.g., by clicking on the “Edit” button). As shown, this results in the surfacing of an OKR editing panel 318. The OKR editing panel 318 includes a number of user interface elements that enable the enterprise user to edit or control various aspects of the OKR and, in particular, the parent objective of the OKR. Particularly relevant to embodiments described herein, such user interface elements include a permissions user interface element 320.

FIG. 3D is a schematic view of the user interface 300 subsequent to the enterprise user providing input consisting of a selection of the permissions user interface element 320 (e.g., by clicking on the “Permissions” button). As shown, this results in the surfacing of a permission settings panel 322 including an alignment permission settings user interface element 324 (e.g., a “Permission settings” dropdown menu according to the embodiment shown in FIG. 3D). In various embodiments, the alignment permission settings user interface element 324 includes a number of options for dynamically controlling the enterprise users who are allowed to align (or contribute) to the particular objective. For example, such options may include (but are not limited to) unlimited viewing and unlimited alignment (e.g., “Anybody can view and align”); unlimited viewing and limited alignment (e.g., “Anybody can view, only selected people can align”), and limited viewing and limited alignment (e.g., “Only selected people can view and align”).

FIG. 3E is a schematic view of the user interface 300 subsequent to the enterprise user providing input consisting of a selection of the unlimited viewing and limited alignment option (or, alternatively, the limited viewing and limited alignment option) via the alignment permission settings user interface element 324. Specifically this results in the surfacing of an alignment control user interface element 326, which is provided in the form of a search box according to the exemplary embodiment shown in FIG. 3D. However, regardless of the form that the alignment control user interface element 326 takes in the particular implementation, such user interface element advantageously enables the enterprise user to select particular enterprise users (or groups of enterprise users, such as particular teams, for example) who are allowed to align (or contribute) to the parent objective. In some embodiments, this includes typing the name, email address, or some other identifying information for such enterprise user(s) (or group(s) of enterprise users).

Once the enterprise user has defined the alignment permission policy, the enterprise user may select a “Done” button 328, for example, to close the alignment permission settings user interface element 324. In some embodiments, this may return the user to the OKR editing panel 318, at which point the enterprise user may select a “Save” button, for example, to save the OKR settings, including the defined alignment permission policy for the OKR.

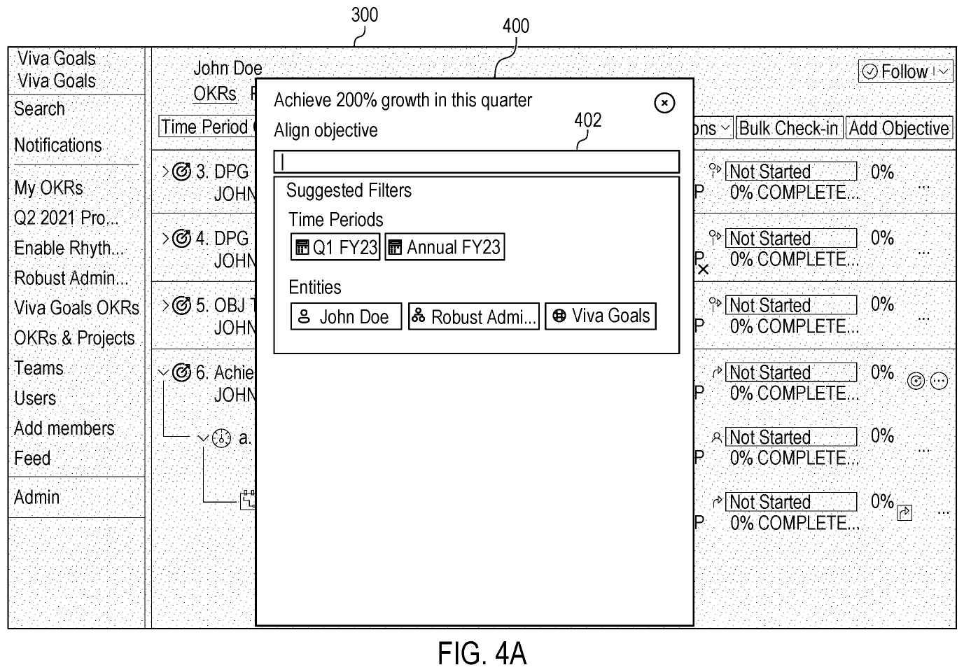

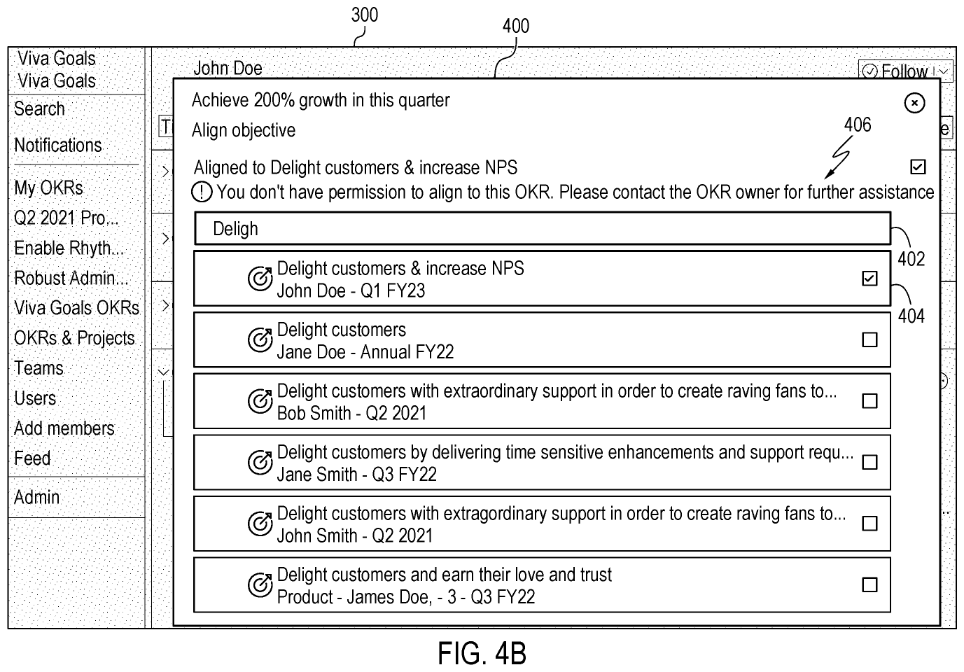

Turning now to the details of the second exemplary implementation, FIGS. 4A and 4B depict the manner in which the techniques described herein can be used to prevent the misalignment of multi-nested OKRs by upholding the defined alignment permission policy for each objective. Specifically, FIG. 4A is a schematic view of the user interface 300 of FIG. 3 subsequent to the enterprise user providing input consisting of a selection of an objective alignment user interface element (not shown). This results in the surfacing of an objective alignment panel 400 including an objective input user interface element 402, which is depicted as a search box for inputting the titles (or other identifying information) for particular objectives to which an enterprise user desires to align.

FIG. 4B is a schematic view of the user interface 300 subsequent to the enterprise user providing input consisting of a selection of a particular objective 404 to which the enterprise user desires to align (e.g., for the exemplary embodiment shown in FIG. 4B, an objective titled “Delight customers & increase NPS”). In particular, assuming that the defined alignment permission policy for the selected objective 404 does not enable the particular enterprise user to align to the objective 404, the selection of the objective 404 within the objective alignment panel 402 results in the surfacing of an error message 406 (e.g., for the exemplary embodiment shown in FIG. 4B, a message stating “You don't have permission to align to this OKR. Please contact the OKR owner for further assistance.”). As a result, the enterprise user is prevented from aligning to the particular OKR. In this manner, the present techniques prevent misalignment of multi-nested OKRs by upholding the alignment permission policy provided by the OKR owner.

FIG. 5 is a block diagram of an exemplary computing system 500 for implementing the techniques described herein. The exemplary computing system 500 includes a processor 502 and a memory 504. The processor 502 may include any suitable type of processing unit or device, such as, for example, a single-core processor, a multi-core processor, a computing cluster, or any number of other configurations. Moreover, the processor 502 may include, for example, an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein.

The memory 504 typically (but not always) includes both volatile memory 506 and non-volatile memory 508. The volatile memory 506 retains or stores information so long as the memory is supplied with power. By contrast, the non-volatile memory 508 is capable of storing (or persisting) information even when a power supply is not available. The volatile memory 506 may include, for example, RAM (e.g., synchronous RAM (SRAM), dynamic RAM (DRAM), synchronous dynamic RAM (SDRAM), and the like) and CPU cache memory. The nonvolatile memory 508 may include, for example, read-only memory (ROM) (e.g., programmable ROM (PROM), electrically programmable ROM (EPROM), electrically erasable ROM (EEROM) or the like), flash memory, nonvolatile random-access memory (RAM), solid-state memory devices, memory storage devices, and/or memory cards.

The processor 502 and the memory 504, as well as other components of the computing system 500, are interconnected by way of a system bus 510. The system bus 510 can be implemented using any suitable bus architecture known to those skilled in the art.

According to the embodiment shown in FIG. 5, the computing system 500 also includes a disk storage 512. The disk storage 512 may include any suitable removable/non-removable, volatile/non-volatile storage component or device. For example, the disk storage 512 may include, but is not limited to, a magnetic disk drive, floppy disk drive, tape drive, Jaz drive, Zip drive, LS-210 drive, flash memory card, memory stick, or the like. In addition, the disk storage 512 may include storage media separately from (or in combination with) other storage media including, but not limited to, an optical disk drive, such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 512 to the system bus 510, a removable or non-removable interface is typically used, such as interface 514 shown in FIG. 5.

In various embodiments, the disk storage 512 and/or the memory 504 function as one or more databases that are used to store data 516 relating to the techniques described herein. Such data 516 may include, but are not limited to, OKR data obtained from the execution of one or more enterprise application(s) 518 on various remote computing systems 520 according to embodiments described herein.

Those skilled in the art will appreciate that FIG. 5 describes software that acts as an intermediary between a user of the computing system 500 and the basic computing resources described with respect to the operating environment of the computing system 500. Such software includes an operating system 522. The operating system 522, which may be stored on the disk storage 512, acts to control and allocate the computing resources of the computing system 500. Moreover, the enterprise application(s) 518, including one or more web-based applications 524 and/or one or more mobile applications 526, take advantage of the management of the computing resources by the operating system 522 through one or more program modules stored within a computer-readable storage medium (or media) 528, as described further herein.

The computing system 500 also includes an input/output (I/O) subsystem 530. The I/O subsystem 530 includes a set of hardware, software, and/or firmware components that enable or facilitate inter-communication between the user of the computing system 500 and the processor 502 of the computing system 500. During operation of the computing system 500, the I/O subsystem 530 enables the user to interact with the computing system 500 through one or more I/O devices 532. Such I/O devices 532 may include any number of input devices or channels, such as, for example, one or more touchscreen/haptic input devices, one or more buttons, one or more pointing devices, one or more accessories, one or more audio input devices, and/or one or more video input devices, such as a camera. Furthermore, in some embodiments the one or more input devices or channels connect to the processor 502 through the system bus 510 via one or more interface ports (not shown) integrated within the I/O subsystem 530. Such interface ports may include, for example, a serial port, a parallel port, a game port, and/or a universal serial bus (USB).

In addition, such I/O devices 532 may include any number of output devices or channels, such as, for example, one or more audio output devices, one or more haptic feedback devices, and/or one or more display devices. Such output devices or channels may use some of the same types of ports as the input devices or channels. Thus, for example, a USB port may be used to both provide input to the computing system 500 and to output information from the computing system 500 to a corresponding output device. Moreover, in some embodiments, the one or more output devices or channels are accessible via one or more adapters (not shown) integrated within the I/O subsystem 530.

In various embodiments, the computing system 500 is communicably coupled to any number of remote computing systems 520. The remote computing system(s) 520 may include, for example, one or more personal computers (e.g., desktop computers, laptop computers, or the like), one or more tablets, one or more mobile devices (e.g., mobile phones), one or more network PCs, and/or one or more workstations. As an example, in some embodiments, the computing system 500 is an application service provider server hosting the enterprise application(s) 518 in a networked environment using logical connections to the remote computing systems 520. In such embodiments, the computing system 500 provides for the execution of the enterprise application(s) 518 on the remote computing systems 520 with the enhanced functionality provided by the techniques described herein.

In various embodiments, the remote computing systems 520 are logically connected to the computing system 500 through a network 534 and then connected via a communication connection 536, which may be wireless. The network 534 encompasses wireless communication networks, such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

The communication connection 536 includes the hardware/software employed to connect the network 534 to the bus 510. While the communication connection 536 is shown for illustrative clarity as residing inside the computing system 500, it can also be external to the computing system 500. The hardware/software for connection to the network 534 may include, for example, internal and external technologies, such as mobile phone switches, modems including regular telephone grade modems, cable modems and DSL modems, ISDN adapters, and/or Ethernet cards.

As described above, the system applications, such as the enterprise application(s) 518, take advantage of the management of the computing resources by the operating system 522 through one or more program modules stored within the computer-readable storage medium (or media) 528. In some embodiments, the computer-readable storage medium 528 is integral to the computing system 500, in which case it may form part of the memory 504 and/or the disk storage 512. In other embodiments, the computer-readable storage medium 528 is an external device that is connected to the computing system 500 when in use.

In various embodiments, the one or more program modules stored within the computer-readable storage medium 528 include program instructions or code that may be executed by the processor 502 to perform various operations. In various embodiments, such program module(s) include, but are not limited to, a multi-nested OKR alignment module 538 that causes the processor 502 to perform operations that result in the execution of the techniques provided herein, as described with respect to the method 100 of FIG. 1 and/or the method 200 of FIG. 2, for example.

It is to be understood that the block diagram of FIG. 5 is not intended to indicate that the computing system 500 is to include all of the components shown in FIG. 5. Rather, the computing system 500 can include fewer or additional components not illustrated in FIG. 5 (e.g., additional applications, additional modules, additional memory devices, additional network interfaces, etc.). Furthermore, any of the functionalities of the one or more program modules/sub-modules may be partially, or entirely, implemented in hardware and/or in the processor 502. For example, the functionality may be implemented with an application specific integrated circuit, in logic implemented in the processor 502, or in any other device.

FIG. 6 is a block diagram of an exemplary network environment 600 for implementing the techniques described herein. As shown in FIG. 6, the network environment 600 includes one or more user computing systems 602 and one or more application service provider servers 604. Each user computing system 602 includes one or more processors 606 and memory 608 communicably coupled to the processor(s) 606. Each user computing system 602 may be implemented as any type of computing system, including (but not limited to) a personal computer, a laptop computer, a tablet computer, a portable digital assistant (PDA), a mobile phone (e.g., a smart phone), an electronic book (e-book) reader, a game console, a set-top box (STB), a smart television (TV), a portable game player, a portable media player, and so forth. FIG. 6 shows representative user computing systems in the forms of a desktop computer 602A, a laptop computer 602B, a tablet 602C, and a mobile device 602D. However, these are merely examples, and the user computing system(s) 602 described herein may take many other forms.

Each user computing system 602 may optionally include one or more enterprise applications 610 (or data corresponding to the execution of such enterprise application(s)) and one or more computer-readable storage media 612 stored in the memory 608, as described with respect to the computing system 500 of FIG. 5, for example. Each user computing system 602 also includes a communication connection 614 by which the user computing system 602 is able to communicate with other devices, including the application service provider server(s) 604, over a network 616. Furthermore, each user computing system 602 includes a display 618, which may be a built-in display or an external display, depending on the particular type of computing system. According to embodiments described herein, the display 618 is configured to surface one or more user interfaces (UIs) 620, including one or more UIs that provide functionalities for dynamically controlling the alignment of multi-nested OKRs during the execution of a goal-setting feature of an enterprise application 610, as described herein.

In various embodiments, the enterprise application(s) 610 are implemented or hosted by the application service provider server(s) 604, which may be provided as one or more server farms or data centers, for example. As an example, in the embodiment shown in FIG. 6, the application service provider server 604 includes multiple servers 604A-J, for example. Moreover, it should be noted that the server components shown in FIG. 6 may each be implemented within any or all of the multiple application service provider servers 604, depending on the details of the particular implementation. Specifically, the application service provider server(s) 604 include one or more processors 622 communicably coupled to memory 624. The memory 624 may include one or more multiple memory devices, depending on the details of the particular implementation. The application service provider server(s) 604 also include one or more communication connections 626 by which the enterprise application(s) 610 described herein may be executed or hosted on the user computing system(s) 602 via the network 616. In particular, the application service provider server(s) 604 provide for execution of the enterprise application(s) 610 on the user computing system(s) 602 by, for example, surfacing one or more UIs 620 associated with the enterprise application(s) 610 on the display 618 corresponding to each user computing system 602.

The memory 624 includes the enterprise application(s) 610 described herein, as well as one or more computer-readable storage media 628. The computer-readable storage medium (or media) 628 includes the multi-nested OKR alignment module 630 described herein (as some portion thereof), which includes computer-executable instructions that cause the processor(s) 622 and/or the processor(s) 606 to implement the techniques described herein. The memory 624 further includes a database 632, which may be configured to store (among other data) OKR data that are utilized according to embodiments described herein.

It is to be understood that the simplified block diagram of FIG. 6 is not intended to indicate that the network environment 600 is to include all of the components shown in FIG. 6. Rather, the network environment 600 may include different components and/or additional components not illustrated in FIG. 6. For example, in practice, the server(s) 602 will include a number of additional components not depicted in the simplified block diagram of FIG. 6, as described with respect to the computing system 500 of FIG. 5, for example.

FIG. 7 is a block diagram of an exemplary computer-readable storage medium 700 for implementing the techniques described herein. In various embodiments, the computer-readable storage medium 700 is accessed by a processor 702 over a computer interconnect 704. For example, in some embodiments, the computer-readable storage medium 700 is the same as, or similar to, the computer-readable storage medium described with respect to the computing system 500 of FIG. 5 and/or the network environment 600 of FIG. 6.

In various embodiments, the computer-readable storage medium 700 includes code (i.e., computer-executable instructions) to direct the processor 702 to perform the operations of the present techniques. Such code may be stored within the computer-readable storage medium 700 in the form of program modules, where each module includes a set of computer-executable instructions that, when executed by the processor 702, cause the processor 702 to perform a corresponding set of operations. In particular, in various embodiments, the computer-readable storage medium 700 includes a multi-nested OKR alignment module 706 that directs the processor 702 to perform the techniques described herein.

Moreover, those skilled in the art will appreciate that any suitable number of the modules shown in FIG. 7 may be included within the computer-readable storage medium 700. Furthermore, any number of additional modules/sub-modules not shown in FIG. 7 may be included within the computer-readable storage medium 700, depending on the details of the specific implementation.

It should be noted that some components shown in the figures are described herein in the context of one or more structural components, referred to as functionalities, modules, features, elements, etc. However, the components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computing systems, discrete logic components, such as application specific integrated circuits (ASICs), and the like, as well as any combinations thereof.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, the terms “component,” “system,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable storage medium.

Moreover, as used herein, the term “computer-readable storage medium” refers to an article of manufacture. In general, computer-readable storage media are used to host, store and/or reproduce computer-executable instructions and data for later retrieval and/or execution. When the computer-executable instructions that are hosted or stored on the computer-readable storage media are executed by a processor of a computing system, the execution thereof causes, configures and/or adapts the executing computing system to carry out various steps, processes, routines, methods and/or functionalities, including the steps, processes, routines, methods, and/or functionalities described herein. Examples of computer-readable storage media include, but are not limited to, optical storage media (such as Blu-ray discs, digital video discs (DVDs), compact discs (CDs), optical disc cartridges, and the like), magnetic storage media (such as hard disk drives, floppy disks, magnetic tape, and the like), memory storage devices (such as random access memory (RAM), read-only memory (ROM), memory cards, thumb drives, and the like), and cloud storage (such as online storage services). Computer-readable storage media may deliver computer-executable instructions to a computing system for execution via various transmission means and mediums, including carrier waves and/or propagated signals. However, for purposes of this disclosure, the term “computer-readable storage medium (or media)” refers specifically to non-transitory forms of computer-readable storage media and expressly excludes carrier waves and/or propagated signals.

The present techniques may be susceptible to various modifications and alternative forms, including (but not limited to) those described in the following examples:
Example 1 is a method for dynamically controlling multi-nested OKR alignment. The method is implemented via an application service provider server including a processor. The method includes: executing, via a network, an enterprise application on a remote computing system; causing surfacing of a user interface on a display of the remote computing system during the execution of the enterprise application, where the user interface corresponds to a goal-setting feature of the enterprise application; receiving, via the surfaced user interface, a user input including an alignment permission policy for a multi-nested Objective and Key Results (OKR) of an enterprise, where the alignment permission policy defines a list of enterprise users who are allowed to align child OKR objects to a parent objective of the multi-nested OKR; and applying the alignment permission policy to the multi-nested OKR.
Example 2 includes the method of example 1, including or excluding optional features. In this example, the method includes performing automatic progress rollups in accordance with the alignment permission policy by only enabling child OKR objects defined by enterprise users who are on the list to roll up to the parent objective.
Example 3 includes the method of example 1 or 2, including or excluding optional features. In this example, the method further includes: executing, via the network, the enterprise application on a second remote computing system; causing surfacing of the user interface on a display of the second remote computing system during the execution of the enterprise application; receiving, via the surfaced user interface, a second user input including an attempt to align to the parent objective; determining whether an enterprise user providing the second user input is on the list of enterprise users who are allowed to align child OKR objects to the parent objective; and updating the OKR to provide the alignment only if the enterprise user is on the list.
Example 4 includes the method of example 3, including or excluding optional features. In this example, the method also includes determining whether the enterprise user providing the second user input is on the list of enterprise users who are allowed to align child OKR objects to the parent objective by: calling an application programming interface in the background when the enterprise user provides the second user input; loading the alignment permission policy in near real-time via the application programming interface; and analyzing the alignment permission policy in near real-time to determine whether the enterprise user is on the list.
Example 5 includes the method of any one of examples 1 to 4, including or excluding optional features. In this example, the method includes applying the alignment permission policy to any secondary objectives that are nested underneath the parent objective.
Example 6 includes the method of any one of examples 1 to 5, including or excluding optional features. In this example, the list of enterprise users includes at least one of an individual enterprise user or a team of enterprise users.
Example 7 includes the method of any one of examples 1 to 6, including or excluding optional features. In this example, the list of enterprise users includes at least one of an individual enterprise user or a team of enterprise users.
Example 8 is an application service provider server. The application service provider server includes a processor, an enterprise application that is utilized by an enterprise, and a communication connection for connecting a remote computing system to the application service provider server via a network. The application service provider server also includes a computer-readable storage medium operatively coupled to the processor. The computer-readable storage medium includes computer-executable instructions that, when executed by the processor, cause the processor to: cause execution of the enterprise application on the remote computing system; cause surfacing of a user interface on a display of the remote computing system during the execution of the enterprise application, where the user interface corresponds to a goal-setting feature of the enterprise application; receive, via the surfaced user interface, a user input including an alignment permission policy for a multi-nested Objective and Key Results (OKR) of an enterprise, where the alignment permission policy defines a list of enterprise users who are allowed to align child OKR objects to a parent objective of the multi-nested OKR; and apply the alignment permission policy to the multi-nested OKR.
Example 9 includes the application service provider server of example 8, including or excluding optional features. In this example, the computer-readable storage medium includes computer-executable instructions that, when executed by the processor, cause the processor to perform automatic progress rollups in accordance with the alignment permission policy by only enabling child OKR objects defined by enterprise users who are on the list to roll up to the parent objective.
Example 10 includes the application service provider server of example 8 or 9, including or excluding optional features. In this example, the communication connection connects a second remote computing system to the application service provider server via the network, and the computer-readable storage medium further includes computer-executable instructions that, when executed by the processor, cause the processor to: cause execution of the enterprise application on the second remote computing system; cause surfacing of the user interface on a display of the second remote computing system during the execution of the enterprise application; receive, via the surfaced user interface, a second user input including an attempt to align to the parent objective; determine whether an enterprise user providing the second user input is on the list of enterprise users who are allowed to align child OKR objects to the parent objective; and update the OKR to provide the alignment only if the enterprise user is on the list.
Example 11 includes the application service provider server of example 10, including or excluding optional features. In this example, the computer-readable storage medium includes computer-executable instructions, when executed by the processor, cause the processor to determine whether the enterprise user providing the second user input is on the list of enterprise users who are allowed to align child OKR objects to the parent objective by: calling an application programming interface in the background when the enterprise user provides the second user input; loading the alignment permission policy in near real-time via the application programming interface; and analyzing the alignment permission policy in near real-time to determine whether the enterprise user is on the list.
Example 12 includes the application service provider server of any one of examples 9 to 11, including or excluding optional features. In this example, the computer-readable storage medium includes computer-executable instructions, when executed by the processor, cause the processor to apply the alignment permission policy to any secondary objectives that are nested underneath the parent objective.
Example 13 includes the application service provider server of any one of examples 9 to 12, including or excluding optional features. In this example, the list of enterprise users includes at least one of an individual enterprise user or a team of enterprise users.
Example 14 includes the application service provider server of any one of examples 9 to 13, including or excluding optional features. In this example, the child OKR objects include at least one of a key result, a project, or a secondary objective.
Example 15 is a computer-readable storage medium. The computer-readable storage medium includes computer-executable instructions that, when executed by a processor, cause the processor to: cause execution of an enterprise application; cause surfacing of a user interface on a display during the execution of the enterprise application, where the user interface corresponds to a goal-setting feature of the enterprise application; responsive to a first user input including a specification of an alignment permission policy for a multi-nested Objective and Key Results (OKR) of an enterprise, apply the alignment permission policy to the multi-nested OKR, where the alignment permission policy defines a list of enterprise users who are allowed to align child OKR objects to a parent objective of the multi-nested OKR; responsive to a second user input including an attempt to align to the parent objective, determine whether an enterprise user providing the second user input is on the list of enterprise users who are allowed to align child OKR objects to the parent objective; and update the OKR to provide the alignment only if the enterprise user is on the list.
Example 16 includes the computer-readable storage medium of example 15, including or excluding optional features. In this example, the computer-readable storage medium includes computer-executable instructions that, when executed by the processor, cause the processor to perform automatic progress rollups in accordance with the alignment permission policy by only enabling child OKR objects defined by enterprise users who are on the list to roll up to the parent objective.
Example 17 includes the computer-readable storage medium of example 15 or 16, including or excluding optional features. In this example, the computer-readable storage medium includes computer-executable instructions that, when executed by the processor, cause the processor to determine whether the enterprise user providing the second user input is on the list of enterprise users who are allowed to align child OKR objects to the parent objective by: calling an application programming interface in the background when the enterprise user provides the second user input; loading the alignment permission policy in near real-time via the application programming interface; and analyzing the alignment permission policy in near real-time to determine whether the enterprise user is on the list.
Example 18 includes the computer-readable storage medium of any one of examples 15 to 17, including or excluding optional features. In this example, the computer-readable storage medium includes computer-executable instructions that, when executed by the processor, cause the processor to apply the alignment permission policy to any secondary objectives that are nested underneath the parent objective.
Example 19 includes the computer-readable storage medium of any one of examples 15 to 18, including or excluding optional features. In this example, the list of enterprise users includes at least one of an individual enterprise user or a team of enterprise users.
Example 20 includes the computer-readable storage medium of any one of examples 15 to 19, including or excluding optional features. In this example, the child OKR objects include at least one of a key result, a project, or a secondary objective.

It should be noted that, while the methods and processes described herein are generally expressed in regard to discrete steps, these steps should be viewed as being logical in nature and may or may not correspond to any specific actual and/or discrete steps of a given implementation. In addition, the order in which these steps are presented in the various methods and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while the methods and processes described herein include various novel features of the disclosed subject matter, other steps (not listed) may also be carried out in the execution of the subject matter set forth in these methods and processes. Those skilled in the art will appreciate that the logical steps of these methods and processes may be combined together or split into additional steps. Steps of the above-described methods and processes may be carried out in parallel or in series. Often, but not exclusively, the functionality of a particular method or process is embodied in software (e.g., applications, system services, libraries, and the like) that is executed on one or more processors of computing systems. Additionally, in various embodiments, all or some of the various methods and processes may also be embodied in executable hardware modules including, but not limited to, system on chips (SoC's), codecs, specially designed processors and/or logic circuits, and the like, on a computing system.

As suggested above, each method or process described herein is typically embodied within computer-executable instruction (or code) modules including individual routines, functions, looping structures, selectors, and switches (such as if-then and if-then-else statements), assignments, arithmetic computations, and the like, that, in execution, configure a computing system to operate in accordance with the particular method or process. However, as suggested above, the exact implementation in executable statement of each of the methods or processes is based on various implementation configurations and decisions, including programming languages, compilers, target processors, operating environments, and the linking or binding operation. Those skilled in the art will readily appreciate that the logical steps identified in these methods and processes may be implemented in any number of ways and, thus, the logical descriptions set forth above are sufficiently enabling to achieve similar results.

While various novel aspects of the disclosed subject matter have been described, it should be appreciated that these aspects are exemplary and should not be construed as limiting. Variations and alterations to the various aspects may be made without departing from the scope of the disclosed subject matter.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for dynamically controlling multi-nested OKR alignment, wherein the method is implemented via an application service provider server comprising a processor, and wherein the method comprises:
executing, via a network, an enterprise application on a remote computing system;
causing surfacing of a user interface on a display of the remote computing system during the execution of the enterprise application, wherein the user interface corresponds to a goal-setting feature of the enterprise application;
receiving, via the surfaced user interface, a user input comprising an alignment permission policy for a multi-nested Objective and Key Results (OKR) of an enterprise, wherein the alignment permission policy defines a list of enterprise users who are allowed to align child OKR objects to a parent objective of the multi-nested OKR; and
applying the alignment permission policy to the multi-nested OKR.

2. The method of claim 1, comprising performing automatic progress rollups in accordance with the alignment permission policy by only enabling child OKR objects defined by the enterprise users who are on the list to roll up to the parent objective.

3. The method of claim 1, further comprising:
executing, via the network, the enterprise application on a second remote computing system;
causing surfacing of the user interface on a display of the second remote computing system during the execution of the enterprise application;
receiving, via the surfaced user interface, a second user input comprising an attempt to align to the parent objective;
determining whether an enterprise user providing the second user input is on the list of enterprise users who are allowed to align child OKR objects to the parent objective; and
updating the OKR to provide the alignment only if the enterprise user is on the list.

4. The method of claim 3, comprising determining whether the enterprise user providing the second user input is on the list of enterprise users who are allowed to align child OKR objects to the parent objective by:
calling an application programming interface in the background when the enterprise user provides the second user input;
loading the alignment permission policy in near real-time via the application programming interface; and
analyzing the alignment permission policy in near real-time to determine whether the enterprise user is on the list.

5. The method of claim 1, further comprising applying the alignment permission policy to any secondary objectives that are nested underneath the parent objective.

6. The method of claim 1, wherein the list of enterprise users comprises at least one of an individual enterprise user or a team of enterprise users.

7. The method of claim 1, wherein the child OKR objects comprise at least one of a key result, a project, or a secondary objective.

8. An application service provider server, comprising:
a processor;
an enterprise application that is utilized by an enterprise;
a communication connection for connecting a remote computing system to the application service provider server via a network; and
a computer-readable storage medium operatively coupled to the processor, the computer-readable storage medium comprising computer-executable instructions that, when executed by the processor, cause the processor to:
cause execution of the enterprise application on the remote computing system;
cause surfacing of a user interface on a display of the remote computing system during the execution of the enterprise application, wherein the user interface corresponds to a goal-setting feature of the enterprise application;
receive, via the surfaced user interface, a user input comprising an alignment permission policy for a multi-nested Objective and Key Results (OKR) of an enterprise, wherein the alignment permission policy defines a list of enterprise users who are allowed to align child OKR objects to a parent objective of the multi-nested OKR; and
apply the alignment permission policy to the multi-nested OKR.

9. The application service provider server of claim 8, wherein the computer-readable storage medium comprises computer-executable instructions that, when executed by the processor, cause the processor to perform automatic progress rollups in accordance with the alignment permission policy by only enabling child OKR objects defined by the enterprise users who are on the list to roll up to the parent objective.

10. The application service provider server of claim 8, wherein the communication connection connects a second remote computing system to the application service provider server via the network, and wherein the computer-readable storage medium further comprises computer-executable instructions that, when executed by the processor, cause the processor to:
cause execution of the enterprise application on the second remote computing system;
cause surfacing of the user interface on a display of the second remote computing system during the execution of the enterprise application;
receive, via the surfaced user interface, a second user input comprising an attempt to align to the parent objective;
determine whether an enterprise user providing the second user input is on the list of enterprise users who are allowed to align child OKR objects to the parent objective; and
update the OKR to provide the alignment only if the enterprise user is on the list.

11. The application service provider server of claim 10, wherein the computer-readable storage medium comprises computer-executable instructions, when executed by the processor, cause the processor to determine whether the enterprise user providing the second user input is on the list of enterprise users who are allowed to align child OKR objects to the parent objective by:
calling an application programming interface in the background when the enterprise user provides the second user input;
loading the alignment permission policy in near real-time via the application programming interface; and
analyzing the alignment permission policy in near real-time to determine whether the enterprise user is on the list.

12. The application service provider server of claim 8, wherein the computer-readable storage medium comprises computer-executable instructions, when executed by the processor, cause the processor to apply the alignment permission policy to any secondary objectives that are nested underneath the parent objective.

13. The application service provider server of claim 8, wherein the list of enterprise users comprises at least one of an individual enterprise user or a team of enterprise users.

14. The application service provider server of claim 8, wherein the child OKR objects comprise at least one of a key result, a project, or a secondary objective.

15. A computer-readable storage medium comprising computer-executable instructions that, when executed by a processor, cause the processor to:
cause execution of an enterprise application;
cause surfacing of a user interface on a display during the execution of the enterprise application, wherein the user interface corresponds to a goal-setting feature of the enterprise application;
responsive to a first user input comprising a specification of an alignment permission policy for a multi-nested Objective and Key Results (OKR) of an enterprise, apply the alignment permission policy to the multi-nested OKR, wherein the alignment permission policy defines a list of enterprise users who are allowed to align child OKR objects to a parent objective of the multi-nested OKR;
responsive to a second user input comprising an attempt to align to the parent objective, determine whether an enterprise user providing the second user input is on the list of enterprise users who are allowed to align child OKR objects to the parent objective; and
update the OKR to provide the alignment only if the enterprise user is on the list

16. The computer-readable storage medium of claim 15, comprising computer-executable instructions that, when executed by the processor, cause the processor to perform automatic progress rollups in accordance with the alignment permission policy by only enabling child OKR objects defined by the enterprise users who are on the list to roll up to the parent objective.

17. The computer-readable storage medium of claim 15, comprising computer-executable instructions that, when executed by the processor, cause the processor to determine whether the enterprise user providing the second user input is on the list of enterprise users who are allowed to align child OKR objects to the parent objective by:
calling an application programming interface in the background when the enterprise user provides the second user input;
loading the alignment permission policy in near real-time via the application programming interface; and
analyzing the alignment permission policy in near real-time to determine whether the enterprise user is on the list.

18. The computer-readable storage medium of claim 15, comprising computer-executable instructions that, when executed by the processor, cause the processor to apply the alignment permission policy to any secondary objectives that are nested underneath the parent objective.

19. The computer-readable storage medium of claim 15, wherein the list of enterprise users comprises at least one of an individual enterprise user or a team of enterprise users.

20. The computer-readable storage medium of claim 15, wherein the child OKR objects comprise at least one of a key result, a project, or a secondary objective.
